(19) United States
(12) Patent Application Publication
(10) Pub. No.: US 2014/0288255 A1
(43) Pub. Date: Sep. 25, 2014

(54) PROCESS FOR PRODUCING HIGH QUALITY NON-HEVEA NATURAL RUBBER

(71) Applicant: Yulex Corporation, Chandler, AZ (US)

(72) Inventors: Jeff Martin, Solana Beach, CA (US); James Mitchell, Ahwatukee, AZ (US); Raymond McCoy, Chandler, AZ (US); Sebastian S. Plamthottam, Upland, CA (US); Victor Covone, Phoenix, AZ (US)

(73) Assignee: Yulex Corporation, Chandler, AZ (US)

(21) Appl. No.: 14/214,614

(22) Filed: Mar. 14, 2014

Related U.S. Application Data
(60) Provisional application No. 61/800,676, filed on Mar. 15, 2013.
(60) Provisional application No. 61/926,628, filed on Jan. 13, 2014.

(51) Int. Cl. C08C 2/02

(52) U.S. Cl. CPC C08C 2/02
USPC 526/340.4

(57) ABSTRACT

Some embodiments of the invention include a process for separating rubber, resin and bagasse from at least a portion of a rubber producing plant including the steps of providing a plant portion and at least partially homogenizing the plant portion in the presence of a resin-solubilizing medium, and extracting rubber using a rubber solubilizing solvent. In some embodiments, the plant portion can include an antioxidant, that in some embodiments, the includes a substantially non-staining antioxidant. Some other embodiments include a process for separating rubber, resin and bagasse from a rubber producing plant comprising the steps of providing a plant portion and applying at least one antioxidant to at least a fraction of the plant portion, milling the plant portion with a milling solvent, and separating rubber form resin using phase separation fractionation. Some embodiments include separation of bagasse and resin components and one or more solvent recovery steps.

### CROSS REFERENCE TO RELATED APPLICATIONS

This application claims the benefit of filing date of U.S. Provisional Application Ser. No. 61/800,676 titled “Process For Producing High Quality Non-Hevea Natural Rubber”, filed on Mar. 15, 2013, the specification of which is incorporated by reference herein in its entirety. This application also claims the benefit of filing date of U.S. Provisional Application Ser. No. 61/926,628 titled “Process For Producing High Quality Non-Hevea Natural Rubber”, filed on Jan. 13, 2014, the specification of which is incorporated by reference herein in its entirety.

### BACKGROUND

Natural Rubber is a polymer of isoprene (2-methyl-1,3-butadiene), and is one of the world's best known natural polymers. Plant-derived natural rubber is predominately comprised of cis-1,4 polyisoprene, which forms a milky suspension or dispersion in water (latex′), and is found in the sap of a variety of plant species such as guayule (Parthenium argentatum), gopher plant (Euphorbia lathyris), mariola (Parthenium incanum), rabbitbrush (Chrysothamnus nauseosus), milkweeds (Asclepias syriaca, speciosa, subulata, et al), goldenrods (Solidago altissima, graminifolia, rigida, et al), pale Indian plantain (Cacalia atripilcifolia), Russian dandelion (Taraxacum Kok-Saghyz), mountain mint (pycnanthemum incanum), American germander (Teucreum canadense) and tall bell flower (Campanula Americana).

Some plant species, such as guayule, thrive in arid and semi-arid regions such as those present in the southwestern deserts of the United States. This potentially provides an opportunity to greatly expand domestic production of natural rubber using land that would otherwise lie dormant. In addition to natural rubber, plant species such as guayule can also be used to produce resin and dry bagasse as by-products of natural rubber production. Plants are typically cultivated, harvested and baled using standard farming practices. Other types of plants will have varying plant maturity rates, and may be harvested using different processes. For example, guayule plants are generally harvested every two years, or at the point where molecular weights of rubber are at sufficient levels to produce a sufficient quantity of rubber (i.e., the natural rubber is of sufficient quality, and the natural rubber yield is cost effective to harvest). The harvest process is generally timed based on desired plant height, weight, and moisture content.

Rubber production in plants such as guayule is highly dependent on environmental factors such as temperature and irrigation levels. As a result, these seasonal conditions are variable from year to year, and directly influence the timing and frequency of the harvesting process. In plants such as guayule, rubber particles are suspended in the cytoplasm, and water availability during growing directly affects the quantity of the final product in the rubber extraction. When the plant becomes dehydrated, the particles can coagulate in situ, irreversibly solidifying the rubber in the plant, even upon re-hydration of the plant. On the other hand, consistently irrigated plants often contain higher levels of cytoplasm-based rubber, and will generally yield a better end product. For example, if the plant contains about 12 percent by weight rubber concentration, a high quality rubber can usually be extracted.

In order to meet certain standards (such as those developed and administered by ASTM International), as well as market requirements and consumer preferences, it is desirable to convert the plant-derived rubber into a block rubber product that is essentially free of resin and other contaminants. Many known processes for the production of natural rubber are not able to produce a block rubber product that is essentially free of resin and/or that meets certain standards in an economically viable and environmentally friendly process. Current processes tend to use large quantities of organic solvents, and are generally focused specifically on natural rubber extraction, without regard for other valuable by-products. Therefore, there is a need in the industry to produce pure natural rubber for applications that demand material that is essentially free of resin, while also providing opportunities to derive other valuable products, such as naturally occurring resin, and dry bagasse from plants such as guayule that have been exposed to variable environmental factors such as temperature, irrigation levels and soil conditions.

### SUMMARY

Some embodiments of the invention include a process for separating rubber, resin and bagasse from a rubber producing plant comprising the steps of providing a plant portion and at least partially homogenizing the plant portion in the presence of a resin-solubilizing medium, and solvating at least some portion of a resin from the plant portion to form a resin solution and bagasse. The process can also include performing a first separation process comprising separating at least a portion of the resin solution from the bagasse, and recovering resin by removing the resin-solubilizing medium and optionally capturing and reusing the resin-solubilizing medium. The process can also include at least partially homogenizing the bagasse in a rubber solubilizing solvent to at least partially de-resinate the bagasse and form a rubber solution, and performing a second separation process comprising separating and isolating at least a portion of the rubber solution and the bagasse. The process can also include processing the rubber solution to produce rubber by removing the rubber solubilizing solvent and processing the bagasse by removing the rubber solubilizing solvent, and drying the rubber and the bagasse. In some embodiments, the plant portion can comprise a whole guayule shrub, or a partially defoliated guayule shrub, or guayule bark. In some embodiments, defoliated guayule shrub is produced using a defoliation assembly comprising two sub-assemblies including at least one cutting head and at least one carrier belt, and at least one defoliating roller head.

In some embodiments, the bagasse is at least partially converted to an animal feed material using a process comprising the steps of at least partially removing any residual resin-solubilizing medium and rubber solubilizing solvent from the bagasse, and agitating the bagasse with at least one alkali metal hydroxide while maintaining a temperature substantially between about 0° C. and about 250° C. to at least partially convert the bagasse to the animal feed material. The process can also include at least partially removing water from the animal feed material using at least one of a dewatering press and a decanter, optionally filtering and recovering the water for reuse, and drying the animal feed material.

In some embodiments, the rubber solubilizing solvent can be optionally recovered for reuse. In some embodiments, the resin solubilizing medium comprises a ketone, and in some embodiments, the ketone comprises 3 to 8 carbon atoms. In some embodiments, the resin solubilizing medium can comprise acetone, or esters, or alcohols, or ethoxylated alcohols, or ethoxylated alcohol and water mixtures, or combinations thereof. In some embodiments, the rubber solubilizing medium can be a linear hydrocarbon comprising 1 to 12 carbon atoms, a cyclic hydrocarbon, an aromatic hydrocarbon, or mixtures thereof, hexane or hexane isomers.

Some embodiments of the invention include a first separation process that is performed using a decanter centrifuge or a screw press. Some embodiments of the invention include a second separation process that is performed using a decanter centrifuge or a screw press.

In some embodiments, the resin-solubilizing medium is removed from the resin using at least one wiped film evaporator, and in some other embodiments, the rubber solubilizing solvent is removed from the rubber solution using at least one wiped film evaporator. In some embodiments, the rubber solubilizing solvent is removed from the rubber solution using a twin screw extruder.

Some embodiments include a guayule solid rubber made according to the process that meets or exceeds a technical grade 10 in accordance with the standard specification for natural Rubber (NR) Technical Grades of ASTM D2227-96 (Reapproved 2007). In some embodiments, the rubber shows a Mooney retention index of at least about 85% after heat aging at 143° C. for 30 minutes in a forced air circulating oven. In some embodiments, the rubber shows a Mooney retention index of at least about 70% after heat aging at 143° C. for 30 minutes in a forced air circulating oven. In some further embodiments, the rubber shows a Mooney retention index of at least about 60% after heat aging at 143° C. for 30 minutes in a forced air circulating oven. In some other embodiments, the guayule solid rubber comprises at least one antioxidant with a concentration from about 0.25 phr to about 3 phr, that meets or exceeds a technical grade 10 in accordance with the standard specification for natural Rubber (NR) Technical Grades of ASTM D2227-96 (Reapproved 2007).

In some embodiments, the plant portion includes at least one added antioxidant, and in some embodiments, the antioxidant comprises a substantially non-staining antioxidant. In some embodiments, the at least one added antioxidant is at least one of a sterically hindered phenol, a hydroquinone derivative, a paraphenylene diamine derivative, a mixture of a sterically hindered phenol and a hydroquinone derivative. In other embodiments, the antioxidant comprises at least one antioxidant selected from a group consisting of a mixture of butylated reaction product of p-cresol and dicyclopentadience (CAS. Reg. No. 68610-51-5) and an aqueous mixture of 2,5-Di(Tert-Amyl)Hydroquinone (CAS. Reg. No. 79-74-3) and Sodium Salts of Polymerized Alkylnaphthalenesulfonic Acid (CAS. Reg. No. 9084-06-4/36290-04-7), Octadecyl 3,5-Di(tert)-butyl-4-hydroxyhydrocinnamate) (CAS. Reg. No. 2082-79-3). a synergistic blend of polymeric hindered phenol and thioester (dilaurylthiodipropionate) (CAS. Reg. No. 68610-51-5 and CAS. No. 123-28-4, N,N′-di-beta-naphthyl-p-phenylenediamine, 55% casein free dispersion (CAS. No. 93-46-9), and a 50% active aqueous dispersion of polymerized 1,2 Dihydro-2,2,4-Trimethylquinoline (CAS. No. 26780-96-1).

Some embodiments include a process for separating rubber, resin and bagasse from a rubber producing plant comprising the steps of providing a plant portion and applying at least one antioxidant to at least a fraction of the plant portion, optionally performing a primary separation step to remove leaf and dirt, and optionally performing a defoliating step and removing corewood. The process can also include performing an extraction step comprising milling the plant portion with a milling solvent, where the milling solvent solvates at least some fraction of rubber from the plant portion to form a rubber solution. The process can include performing a solids removal stage to at least partially separate fiber and solids from the rubber solution. The process can also include performing a purification step by inducing phase separation of the rubber solution at least once by mixing the rubber solution with a fractionation solvent. In this instance, the fractionation solvent can solvate at least some fraction of resin from the rubber solution to enable separation of resin from the rubber solution.

In some embodiments, the milling solvent can include at least one antioxidant. Some embodiments include a fractionation solvent that comprises a polar solvent. In some embodiments, the fractionation solvent comprises acetone. In some embodiments, phase separation of the rubber solution and fractionation solvent is induced by mixing the rubber solution with acetone at a temperature between about 32° C. and about −78° C. The process can also include a purification step that comprises two sequential phase separation steps.

Some embodiments also include at least partially removing milling solvent and increasing the viscosity of the rubber solution, and processing the rubber solution using a devolatilizing extruder, extruding rubber, and optionally capturing the milling solvent for reuse.

In some embodiments, the process also includes at least partially removing milling solvent, increasing the viscosity of the rubber solution, optionally capturing the milling solvent for reuse, and at least partially converting the rubber solution into a rubber latex solution through the addition of at least one emulsifier.

In some embodiments, the at least one emulsifier comprises at least one of an anionic, non-ionic, and cationic surfactant. In some embodiments, the at least one emulsifier includes an anionic emulsifier comprising rosin acid soaps, potassium salt of rosin acid, potassium oleate, and sodium salt of alkyl benzene sulfonic acid

### DESCRIPTION OF THE DRAWINGS

FIG. 1 provides a flowchart illustrating a process for producing non-hevea natural rubber according to one embodiment of the invention.

FIG. 2 provides a flowchart illustrating a process for converting guayule fiber into animal feed according to one embodiment of the invention.

FIG. 3A-3B provides a side perspective view of a defoliation assembly comprising two sub-assemblies in accordance with one embodiment of the invention.

FIG. 4 provides one illustration of a production process for producing non-hevea natural rubber according to one embodiment of the invention

FIG. 5A shows a first portion of a process flowchart illustrating a process for single solvent extraction with a cryogenic extraction stage according to another embodiment of the invention.

FIG. 5B shows a second portion of a process flowchart illustrating a process for single solvent extraction with a cryogenic extraction stage according to another embodiment of the invention.

FIG. 5C shows a third portion of a process flowchart illustrating a process for single solvent extraction with a cryogenic extraction stage according to another embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Natural Rubber is a polymer of isoprene (2-methyl-1,3-butadiene). Plant-derived rubber as referred to herein generally refers to a naturally occurring hydrocarbon polymer of isoprene which is typically predominately comprised of cis-1,4 polyisoprene. However, embodiments of the invention are not intended to be limited to embodiments shown, but are to be accorded the widest scope consistent with the principles and features disclosed herein. Skilled artisans will recognize the examples described herein include methods and processes that can be suitable for naturally occurring hydrocarbon polymers of isoprene, including cis-1,4 polyisoprene, and as such can comprise a variety of molecular weights and a range of molecular weight distributions. It will also be recognized that differences in molecular weights and molecular weight distributions can vary widely, not only between plant species, but from harvest to harvest, and between plants from the same harvest. Therefore, it should be recognized that methods and processes described herein can be practiced using a plant-derived rubber with a naturally occurring varying molecular weights and molecular weight distribution.

Plant-derived rubber, which forms a milky suspension or dispersion in water (‘latex’), is found in the sap of a variety of plant species such as guayule (Parthenium argentatum extracted from plant materials such as guayule. The microstructure, molecular weight and molecular weight distribution can vary depending on the plant species. In some embodiments, the whole harvested shrub including the leaves (after partial drying) can be subjected to the processes disclosed herein. The terms “whole plant” or “whole shrub” refer to the complete plant or shrub including the roots, base, stem, branches and leaves, and also includes pollarded plants or shrubs. In general, the rubber found in plants in the field can include coagulated and/or dry rubber. This is especially the case if the growing season has been seasonally dry, or if the plants have experience low levels of irrigation. Moreover, any residual rubber latex in a harvested plant can coagulate and/or dry during harvesting, drying, shipping, and storage.

Unless specified or limited otherwise, the term “pure rubber” is meant to encompass a rubber that is substantially free of non-rubber constituents such as naturally occurring resin. Furthermore, unless specified or limited otherwise, the rubber that can be produced using some embodiments of the invention as described herein can comprise pure rubber that is able to meet the ASTM D2227-96 (Reapproved 2007) specifications for grade L, grade CV, grade 5, grade 10 and grade 20 for technically classified rubber.

The term “resin” as used herein is meant to encompass components comprising terpenes, terpenoids, glycerides of fatty acids, wax components, and other components that are extracted from the plant material such as guayule using a polar solvent such as acetone. In general, the resin composition can vary depending on the plant type, age etc.

The term “dry bagasse” as used herein is meant to encompass substantially all plant material remaining after extraction of resin and rubber. In other words, the dry bagasse will be substantially free of resin (for example, less than 1 weight percent) and any residual solvents following processing using at least some of the embodiments described herein.

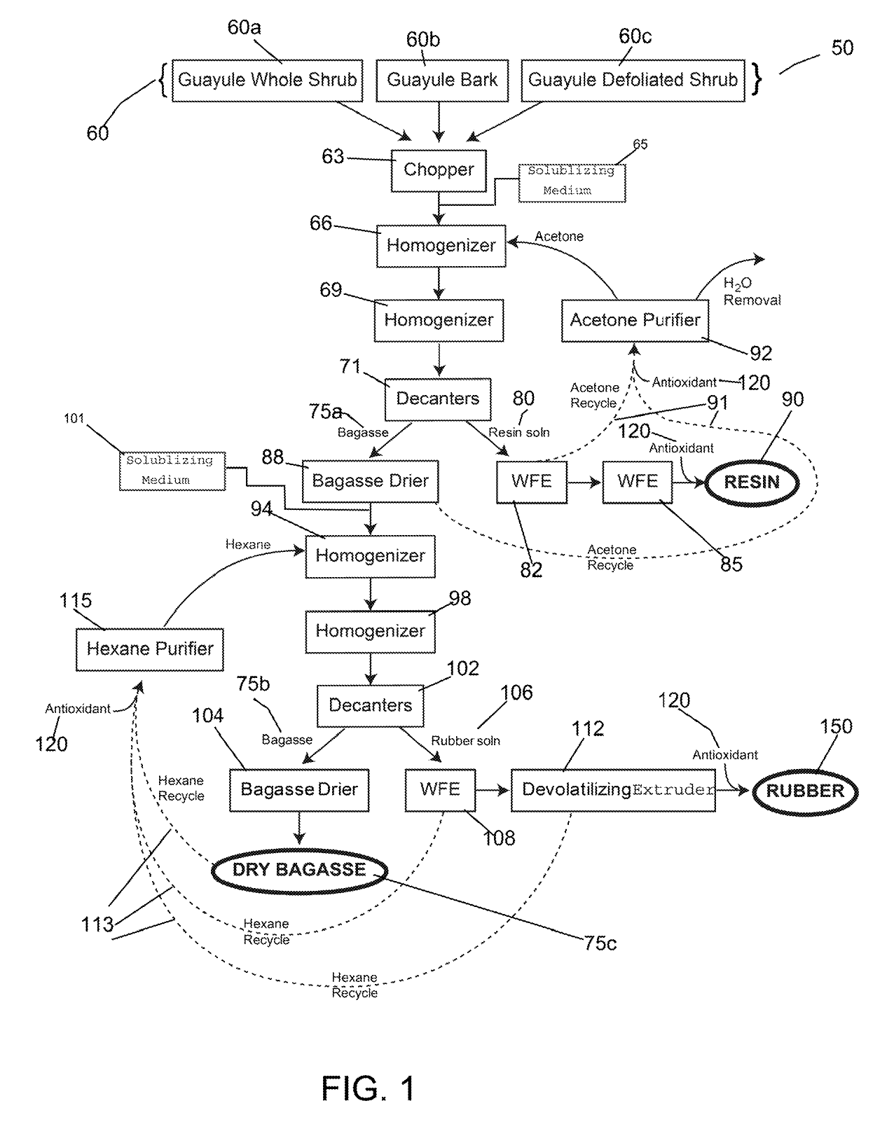

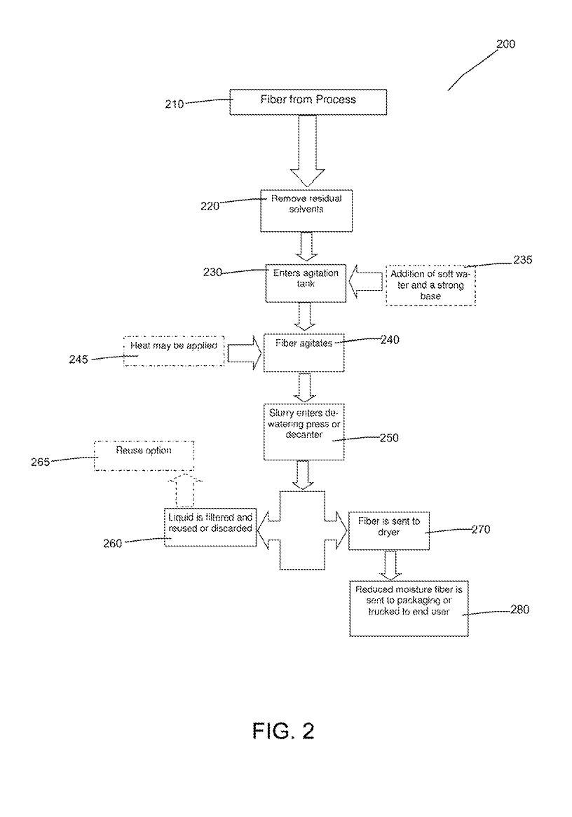

Some embodiments include one or more processes for producing plant-derived rubber using some portion of a guayule plant or guayule shrub (and can include the roots, base, stem, branches and leaves, and also pollarded plants as mentioned above). As used herein, the term guayule plant and guayule shrub can be used interchangeably. Referring to FIGS. 1, 4, 5A-5C, guayule shrub 60 can include any whole or partial guayule plant, and/or any whole or partial guayule shrub. Further, as used herein, the guayule shrub 60 can comprise a guyuale whole shrub 60a, guyuale whole bark 60b, guyuale whole defoliated shrub 60c. FIG. 1 provides a flowchart 50 illustrating a process for producing non-hevea natural rubber 150 according to one embodiment of the invention, and FIGS. 2, 4, and 5A-5C provide illustrations of production process for producing non-hevea natural rubber 150 according to other embodiments of the invention. As shown, in some embodiments, the processes 50, 200 can utilize a guayule plant matter 60 in various forms, including guayule whole shrub 60a, guayule bark 60b, or least partially defoliated guayule shrub 60c.

In some embodiments, example harvesting, defoliation, debarking, and size reduction processes suitable for the producing a guayule shrub 60 suitable for processing using the methods and processes described herein are detailed in U.S. Pat. No. 7,923,039, which is incorporated by reference in its entirety. Using guayule shrub 60 as an example species, in one embodiment of the invention, the harvest process can include harvesting by hedging or pollarding the plant (cutting the trunk of the plant above the root base), so that only above-ground portions of the plant are harvested and subsequently processed. In general, the timing of the harvest is determined by an assay to quantify the concentration of rubber prior to extraction according to the method disclosed herein. In another embodiment of the harvest process, the entire plant is dug from the ground and the shoots and roots are subsequently processed. In yet another embodiment of the invention, guayule shrub 60 can be at least partially processed in the field into smaller parts to allow improved packing densities as the plant is baled or packed into carts, hoppers, containers or trucks for transportation to the processing plant. Depending on weather conditions, guayule shrub 60 can be harvested several times. For example, a crop can be irrigated for two years before the first winter harvest, then pollarded in the spring, and re-harvested the following spring. When the plants are pollarded during the harvest process, the plants will re-grow for another harvest in the future.

In various embodiments of the invention as described, leaves, flower parts, small stems and other plant parts that contain lower concentrations of extractable rubber 150 and/or resin 90 can be removed during a defoliation step in the field, or removed at a processing facility. In some embodiments, this optional step can minimize contaminants (such as waxes). In some embodiments, plants and plant portions (e.g. guayule shrub 60) can be defoliated using mechanized shearing, hand shearing, hedge shearing, or with non-dehydrating chemical defoliants. For example, in some embodiments, defoliation can be performed using a gravity-based conveyor belt system, washing steps, and/or air or water pressure to remove leaves. In an alternate embodiment, the process does not include defoliating the plants.

In certain aspects of the invention, defoliation is accompanied by air density separation, which separates the small leaves and stems from the rest of the plant. In some embodiments, this separation can occur within a separator chamber via forced air from a blower. Using this process, the forced air can lift the lighter leaves, flower parts, small stems, and dirt from the heavier bark and woody pulp of the chopped plant. The leaves, flower parts and small stems can be air conveyed, and can be collected for biomass reuse. In some embodiments, the blower can be located downstream of the separator chamber. In this instance, the separator system is operated at negative pressure, and air enters through baffles in the bottom of the separator chamber under vacuum pressure. In some embodiments, the blower is further capable of forcing sufficient air capacity to lift leaves, flower parts, stems, and dirt. In some embodiments, air flow can be adjusted depending on the desired particle size. In some other embodiments for example, within the separator chamber, the light pieces (leaves, flower parts and small stems) can be separated by fluidization, internal baffles, and/or flow, where the leaves, flower parts and small stems are separated from the air, and discharged at the bottom of the separator chamber through a rotary airlock feeder.

In some embodiments, an air density separator system suitable for large scale processing is a high capacity system manufactured by Carver Inc.-Lummus Corp. (Savannah, Ga.). This system can be suitable to discharge chopped larger sized woody pieces and bark out of the bottom of the separator system as feedstock for further processing. For example, in one embodiment, the blower can be set to a bulk pressure lift point somewhere between the weight of the bulk of the plant and bark pulp (for example to a pressure of 12-13 lbs/ft³), and the weight of the leaves, flower parts and small steps (for example to a bulk pressure of 4-8 lbs/ft³). In this instance, the separation takes place based on the difference in density, and a greater difference between the two densities makes separation easier. In some other embodiments, additional separation system steps can be optionally used where the difference is smaller. For example, some embodiments can include modifications to the blower set with corresponding air flow geometry and cross-sectional velocity, based on the weights of the materials, or the scale of the separator chamber, to allow the material to be separated by air fluidization. In another embodiment, the separator system comprises separation by mechanical or human separation. For example, the separator system can comprise hand shearing or hedging the leaves and small stems in the field.

In some embodiments, leaves, flower parts, and stems separated from the rest of the guayule plant using the separator system, can be sent for biomass collection. For example, in some embodiments, the collected leaves and stems can be processed by a bio-refinery into a variety of ligins or resins, and used in a variety of products, such as bio-adhesives, coatings, bio-pesticides, antifungal agents, and anti-termitic agents. In some embodiments for example, leaves, flower parts and stems can also be processed into cellulose or hemi-cellulose and used for a variety of bio-fuels, such as ethanol, and other bio-products, such as insulation. Any leaves, flower parts and stems can also be spread back on agricultural fields as mulch, or combined with other by-products of the process. Further, any larger pieces (e.g., bark, chopped plant, and pulp) can be discharged from the separator system for further processing. In some embodiments, conveyance methods include convectional conveying equipment including but not limited to, augers, belt conveyors, hand, bucket elevators, or other similar solids handling equipment.

In some embodiments, it can be desirable to use only the bark and/or branch portions of the guayule shrub 60. For example, in the case of guayule shrub 60, the bark portions of the roots, stems, and branches contain the majority of the rubber in the plant, while the branches contain a higher percentage of rubber and resin than the main stem and roots. In such embodiments, the plant material can de-barked (or decorticated) and only the bark portions of the plant material used in order to increase separation efficiency and reduce the amount of solid material processed for extraction of purified resin (resin 90) and rubber 150. In some embodiments of the invention, a greater percentage of resin 90 and rubber 150 is extracted in initial separation steps, thereby decreasing the need for extensive processing in later stages.

In some further embodiments, the de-barking can comprise high pressure washing or air jets to strip the bark off the plant. Some embodiments include debarking using a mechanical method to strip the bark from the plant. Some embodiments can also include debarking steps that can also comprise manual de-barking, using hand stripping of the bark from the plant. In further embodiments, root systems or root balls of the plants, or entire plants, can be used. In some embodiments, the de-barking can be performed simultaneously with a defoliation step.

In some embodiments, the whole harvested guayule shrub 60 including the leaves after partial drying can be subjected to the above process, or optionally the guayule shrub 60 can be defoliated, or in another case the guayule shrub 60 can be debarked. In the above process, after harvesting, the guayule shrub 60 is initially chopped into substantially uniform size pieces using conventional equipment such as mills, anvil choppers, hammer-mills, roll mills, stone mills, bowl-mills, pulp-mills and the like. Optionally, leaves, flower parts, small stems, etc. can be removed during the defoliation step. As used herein, the terms chopped can generally include mechanically cutting, tearing, deformation and/or a combination thereof. In most instances, a guayule shrub 60 subjected to a chopping process by any of the methods described herein will at least partially increase the surface area of the guayule shrub 60, and/or increase the number of discreet or partially coupled portions of the guayule shrub 60.

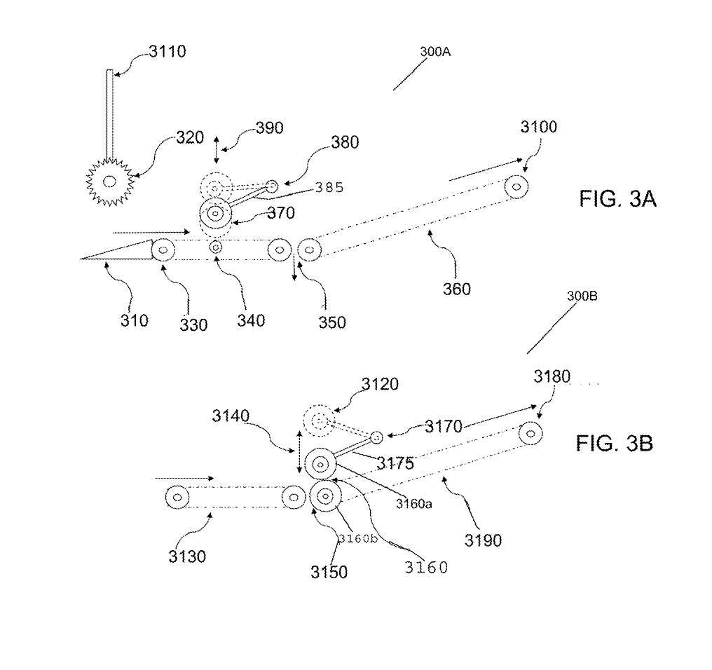

Some embodiments include a process for mechanical defoliation with chemical defoliation. For example, some embodiments provide a defoliation assembly comprising two coupled sub-assemblies 300A, 300B that can at least partially mechanically defoliate a natural rubber 150 containing plant or shrub. In some embodiments, the process can include a series of steps for mechanical defoliation with chemical defoliation using the defoliation assembly sub-assemblies 300A, 300B. In some embodiments, a process for mechanical defoliation with chemical defoliation includes at least partially processing a natural rubber containing plant or shrub (for instance guayule shrub 60) with the defoliation assembly comprising sub-assemblies 300A, 300B. As shown in FIG. 3A, in some embodiments, the process for mechanical defoliation with chemical defoliation can include mechanically defoliating a guayule shrub 60 using a cutting head 310. In some embodiments, the cutting head 310 can comprise rotating blades at an intersection. In some other embodiments, the cutting head 310 can include a continuous cutting chain that connects with the guayule shrub 60 causing it to sever the guayule shrub 60 near the base and root crown.

In some embodiments, the defoliation assembly sub-assemblies 300A, 300B also include a brush assembly mounting point 3110. As shown in FIG. 3A, the sub-assembly 300A can include a self-propelled rotating brush assembly 320 coupled to the mounting point 3110 which can guide the cut plant 60 to a carrier belt 330. In some embodiments, the brush assembly 320 can be coupled to the main frame of a harvester or harvest head. Some embodiments include a brush assembly 320 that can be electrically, mechanically or hydraulically motivated. Some embodiments include a powered carrier belt 330 to revive the cut plant 60. In some embodiments, the powered carrier belt 330 can be electrically, mechanically or hydraulically motivated to convey the guayule shrub 60 to the defoliating roller heads 370. In some embodiments, the sub-assembly 300A can include a secondary carrier belt 360 that can be used to convey the guayule shrub 60 to an uplift carrier belt or holding bin attached in the harvester.

In some embodiments, the sub-assembly 300A can include a primary defoliated roller head 370. In some embodiments, the primary defoliated roller head 370 can be electrically, mechanically or hydraulically motivated. In some further, embodiments, the primary defoliated roller head 370 can rotate and apply pressure to the plant 60 causing dehydrated leaf to be crushed and separated from the stem of the guayule shrub 60. Some embodiments include a defoliating roller head main pivot point 380. In some embodiments, a lifting resistance of the defoliating roller head main pivot point 380 can be set or adjusted by means of a conventional torsion rod, or conventional compression or extension spring assembly. In some embodiments, the adjustment of the defoliating roller head main pivot point 380 can be used to apply pressure to the roller head 370. In some embodiments, the pressure applied to the guayule shrub 60 can be varied by adjustment of the defoliating roller head main pivot point 380. Moreover, in some embodiments, adjustment of the pressure applied to the guayule shrub 60 can enable the passage of various sizes of guayule shrub 60 to pass through the roller head 370 assembly. In some further embodiments, an idler roller 340 can reside under the primary carrier belt 330, and can act as a support or secondary roller head. Some embodiments include a transitional gap 350 between carrier belts 330, 360 to allow for the removal of leaf materials by gravity or air fan. In some embodiments, during operation, the roller head 370 can incur an upward and downward movement 390 as it pivots on a fixed arm 385.

In some embodiments, a secondary carrier belt motor assembly 3100 can be used to produce linear movement of a carrier belt 360. As shown in FIG. 3B, some embodiments include a sub-assembly 300B with a defoliating roller head 3160a at a point 3120. During these circumstances, the defoliating roller head 3160a can now be a component of the secondary carrier belt drive motor, allowing for upward and downward movement (shown as movement 3140) to accommodate plants or shrubs of various sizes. In some embodiments, the defoliation sub-assembly 300B can include a roller head assembly 3160 that can contain two roller heads 3160a, 3160b, and in some embodiments, the two roller heads 3160a, 3160b can at least partially couple together. In some other embodiments, the two roller heads 3160a, 3160b can impinge upon one another. In other embodiments, the roller heads 3160 can be separated by a distance (e.g., represented by movement 3140) and can be at least partially coupled as a plant or shrub 60 passes between the two roller heads 3160a, 3160b. In some further embodiments, the two roller heads 3160a, 3160b can apply a force to a plant 60 as the plant 60 at least partially passes between the two roller heads 3160a, 3160b of the roller head assembly 3160. In some embodiments, the roller head assembly 3160 can create a force to at least partially crush a plant or shrub's leaf material. In some embodiments, the roller head assembly 3160 can create a force to at least partially crush a dehydrated leaf material between the roller heads 3160a, 3160b.

Some embodiments include primary carrier belt 3130 which feeds shrub 60 to the defoliating roller heads 3160a, 3160b. In some embodiments, the carrier belt 3130 can utilize a conventional chain mesh construction. In this instance, in some embodiments, the chain mesh construction of the carrier belt 3130 can allow leaf materials to fall through during use. In some embodiments, operation of the defoliation sub-assembly 300B can include upward and downward motion (movement 3140) of the roller head 3160a which accommodates size variations of the shrub 60. In some embodiments, the secondary carrier belt power unit (comprising the assembly 3160 as mentioned earlier) can also provide shrub 60 movement through the roller heads at point 3150. In some embodiments, the roller head assembly 3160 can create a force to at least partially separate the stem of the shrub 60. In some embodiments, the roller head assembly 3160 can create a force between the roller heads 3160a, 3160b to at least partially separate the stem of the shrub 60 without damaging the stem. Some embodiments can include defoliation assembly sub-assemblies 300A, 300B with roller heads 370, 3160a, 3160b that can be at least partially covered with rubber 150 or other suitable elastomeric material. In some other embodiments, the defoliation assemblies 300A, 300B can include roller heads 370, 3160a, 3160b that can comprise a metal surface. In some embodiments, the metal surface can include a roughened surface, an irregular surface, or a grooved surface. In this instance, the metal surface can at least partially enhance traction between the roller heads and the plant or shrub 60 materials.

Some embodiments include a transitional gap 3150 between carrier belts 3130, 3190 to allow for the removal of leaf materials by gravity or air fan. In some embodiments, during operation, the roller head 3160a can incur an upward and downward movement 3140 as it pivots on an arm 3175 coupled to a pivot point 3170. In some embodiments, an adjustable pivot point 3170 can be of any length. In some embodiments, a lifting resistance can be set or adjusted using a torsion rod, compression or extension spring assembly. In some embodiments, the pressure applied to the plant or shrub 60 can be varied by adjustment of the defoliating roller head main pivot point 3170. In some embodiments, the pressure applied to the plant or shrub 60 can be adjusted, which can enable the passage of various sizes of shrub 60 through the roller head assemblies 3160. For example, in some embodiments, the adjustment of the defoliating roller head main pivot point 3170 or other biasing device can be used to apply pressure to the roller head 3160a.

Some embodiments include a defoliation assembly sub-assembly 300B with a secondary carrier belt motor assembly 3180 coupled to, and driving a secondary carrier belt 3190. In some embodiments, the secondary carrier belt motor assembly 3180 can at least partially move the carrier belt 3190. In some embodiments, the secondary carrier belt 3190 can be used to convey a plant or shrub 60 to an uplift carrier belt, or to a holding bin attached in the harvester. In some embodiments, the carrier belt 3190 can include at least one aperture. Some embodiments include a carrier belt 3190 with a plurality of apertures. In some embodiments, the one or more apertures can allow passage and at least partial removal of leaf. In some embodiments, a leaf material can pass through the one or more apertures under gravity. In some other embodiments, a leaf material can pass through the one or more apertures assisted by pressurized air, or other gas.

Referring now to FIG. 1, illustrating a process for producing non-hevea natural rubber 150, in some embodiments, a feedstock including guayule shrub 60 can be chopped (step 63). For example, in some embodiments, prior to homogenization and extraction steps, guayule shrub 60 can be chopped into a relatively uniform size or shape. In some embodiments, chopping is performed on the whole plant material (e.g., whole shrub 60a). In other embodiments, chopping is performed on defoliated plant material (e.g., guyuale whole defoliated shrub 60c), or on the bark portions of the plant (e.g., guyuale whole bark 60b). In some further embodiments, chopping is performed before or at the same time as defoliation and/or debarking Plant piece chopping size is dependent on desired scale, technique, use, and preferred end product. For example, piece sizes can range from smaller than about 12 inches to larger than about 8 inches, with an average size of 3-6 inches for maximized extraction of rubber 150. If the plant is chopped too finely, losses of extractable rubber 150 will be greater due to oxidation and dehydration of a higher surface area of exposed chopped plant.

In some embodiments, the chopper can include any type of chopping equipment, including blenders, mills, anvil choppers, or other types of choppers. The chopper capacity optionally reflects the desired manufacturing scale. For example, on a laboratory scale, a chopper would process about ¼ lbs of plants per hour, while at the pilot plant scale 500-1,000 lbs per hour might be processed. At the commercial scale, the chopper would be capable of processing 1,000 lbs or more of plants per hour for example.

In some embodiments, following the chopping step 63, material including guyuale shrub 60 can be continuously fed and subjected to high-speed homogenization and grinding in the presence of a resin-solubilizing medium 65. For example, some embodiments of the invention can include a homogenizer step 66, and a homogenizer step 69. In some embodiments, homogenization performed by the homogenizer steps 66, 69 can continue until a final particle size in the range of about 10 microns to 600 microns is achieved. As used herein, homogenizers are typically rotor-stator assemblies that can be suitable for rapid disruption of plant tissues. Appropriately sized plant material is drawn into the rotor-stator assembly, the material is centrifugally thrown outward and exit through the slots in the static head, the plant tissues are ruptured by a combination of extreme turbulence, cavitation, and shearing. Efficiency depends on the size of the rotor stator, rotor tip speed (depends on diameter and rpm). Capacities can range from small lab units to large production type units (tons/hr). In some embodiments, high speed, high shear continuous feed homogenizers as manufactured by IKA, Tekmar, Silverson, Ross, Arde Barinco Inc. can be used with a rotor speed from about 1000 to about 20,000 rpm. For example, the continuous high shear homogenizer mixer (Cavitron®) from Arde Barnico Inc. 875 Washington Av, Carlstadt, N.J. 07072) can be used. Cavitron® is a registered trademark of Cavitron GmbH. In some embodiments, the homogenization step can include one or more of the following: blending, mixing, solubilizing, suspending, dispersing, disintegrating, disrupting, emulsifying, dispersing, stirring etc. In some embodiments, a residence time of less than about 5 minutes is required to dissolve and extract all the resin from the guayule shrub 60 in the presence of a suitable solubilizing medium 65.

In some embodiments, the solubilizing medium 65 can comprise hexane, cycohexane, toluene and the like, or a blend of solvents. In some other embodiments, the resin-solubilizing medium 65 can be ketones with 3 to 8 carbon atoms, esters, alcohols and the like. For example, suitable solvents can be selected using solubility parameter (Hildebrand or Hansen). The solubility parameter of the resin-solubilizing medium 65 and resin 90 combination can be selected to be within the range of interaction radius or radius of sphere in Hansen space. In some embodiments, the solubilizing medium 65 for the resin 90 is a ketone such as acetone.

Some embodiments include a first separation process 71 to separate the acetone solubilized resin 90 (resin solution 80) from a bagasse 75a. In some embodiments, the first separation process 71 can comprise decanting. In some other embodiments, a conventional screw-press can be used. Moreover, in some embodiments, the acetone and resin solution 80 can be separated from the bagasse 75a mixture in a continuous manner. In this instance, the separation can occur using an explosion proof decanter centrifuge such as a model SG2 manufactured and sold by Alfa Laval Inc 5400 International Trade Drive, Richmond, Va. 23231. The equipment contains two basic moving parts including a bowl which rotates between about 100 to about 5,000 rpm, producing more than 4,000 G's, and a scroll conveyor defining a differential speed for conveying or discharging solids (which runs at a range of between about 1 to about 70 rpm). In some embodiments, centrifuge equipment from other decanter centrifuge manufacturers can include Westfalia, Flottweg, Centrisis, Peralisy, Bird, Contect, and Sharples. In other embodiments, other equipment can be used, for example, conventional presses, filter presses, rotary presses, vacuum presses, cartridge filters, membranes, microfiltration, nanofiltration, natural settling, settling tanks, vertical centrifuges, high speed centrifuges, disc stack centrifuges and separators. In some further embodiments, other separation techniques can be used such as filtration, centrifugation, and the like.

In some embodiments, following the first separation process 71, the separated extracted resin solution 80 in acetone can be continuously fed into a plurality of wiped film evaporators to bring the solvent residue levels in the resin 90 to low ppm levels. For example, in some embodiments, the resin solution 80 can be passed to a first wiped film evaporator 82. In some embodiments, the resin solution 80 can be passed to a second wiped film evaporator 85. In wiped film evaporators suitable for use in the methods as described include those from Pfaudler. In other embodiments, at least about two other evaporation technologies could also be used such as falling film evaporators, plate or cassette evaporators, scrape surface evaporators. In some embodiments, the acetone from the wiped film evaporators 82, 85 can be removed and recovered 91 using a solvent recovery unit 92 with condensers in the form of a heat exchanger like plates, shell and tube, cassettes, etc. In some embodiments, acetone removed and recovered 91 can comprise antioxidant 120. In some further embodiments, optionally, an antioxidant 120 can be added to the solvent to prevent any degradation of the extractables components (i.e. resin 90). Other process such as precipitation using a non-solvent such as water can also be used to fractionate or separate different components of the resin 90 or to remove the all components of the resin 90. In some embodiments, the resin-solubilizing medium 65 (such as acetone) can then be recycled. Further, in some embodiments, antioxidant 120 can be added to the resin 90 to help stabilize and prevent oxidative degradation of the resin 90.

In some embodiments, the bagasse 75a separated in the first separation process 71 can be dried and/or solvent can be removed in a step 88. In some embodiments, acetone can be removed and recovered 91 in the solvent recovery unit in step 92, and purified and delivered to acetone solvent storage tanks. In some embodiments, the acetone solvent can be fed back into the resin 90 dissolution homogenizers (homogenizer step 66 and subsequently into homogenizer step 69) as required to complete the continuous process loop.

Some embodiments of the process 50 can include one or more additional homogenization steps. For example, some embodiments include at least a homogenization step 94. Some embodiments also include a homogenization step 98. In this instance, at least partially dried bagasse 75a can be fed continuously into a high sheer mixer with a rotor speed of about 10-500 rpm in the presence of a solvent (solubilizing medium 101). In some embodiments, the rotor rpm can be from about 1000 to about 20000 rpm and residence time less than about 10 minutes, preferably less than about 5 minutes. In some embodiments, the residence time will depend on the temperature and the rpm or tip speed of the homogenizer.

The solubility parameter of the solubilizing medium 101 and rubber 150 component can be selected to be within the range of interaction radius or radius of sphere in Hansen space. For example, in some embodiments, a hydrocarbon solvent can be used such as alkanes (from about 4 to about 9 carbon atoms), cyclic hydrocarbon such as cycloalkanes (from about 5 to about 10 carbon atoms), or aromatic hydrocarbon solvents (from about 6 to about 12 carbon atoms). Some embodiments can utilize a solubilizing medium 101 comprising hexane or isomers of hexane. In some further embodiments, optionally, an antioxidant 120 can be added in the solubilizing medium 101, or injected into the mixer (e.g., in steps 94 and 98).

Some embodiments include a second separation process 102. In some embodiments, a second separation process 102 can be used to separate the rubber solution 106 in hexane from the bagasse 75b. In some embodiments, the second separation process 102 can comprise decanting. Moreover, in some embodiments, the rubber solution 106 in hexane can be separated from the bagasse 75b mixture in a continuous manner. In some embodiments, other separation techniques can be used such as filtration, centrifugation, screw press and the like.

In some embodiments, the solution 106 is separated and can be fed into a series of wiped film evaporators to concentrate the rubber 150 and remove all the trace levels of solvent. In some embodiments, the solubilizing medium 101 can then be recovered using a solvent recovery and purification unit 115, and the solubilizing medium 101 recycled and fed to the extraction and precipitation operation zones. In some embodiments, a separated clean rubber solution 106 (comprising rubber 150) can be at least partially concentrated using a wiped-film evaporator in step 108. In some embodiments, the at least partially concentrated clean rubber solution 106 can then be fed into a single or twin screw devolatilizing extruder 112. Some embodiments include a devolatilizing extruder 112 with vacuum stripping capability and screw speed from 200 rpm to 1500 rpm from NFM/Welding Engineers Inc. In some embodiments, an antioxidant 120 can be added in the finishing step in the extruder 112 at the injection barrel.

In some embodiments of the invention, the rubber 150 in the form of dry crumb can be extruded out from the extruder 112. In some embodiments, the extruder 112 can comprise different multiple process zones for precipitating the rubber 150, separating the resin 90 solution, washing with resin 90 soluble solvents, removing the solvent mixture, and mixing with one or more stabilizers. In some embodiments, the stabilizer can comprise at least one antioxidant 120. Further, in some embodiments, at least one antioxidant 120 can comprise a stabilizer 120, and the terms stabilizer and antioxidant are used interchangeably herein.

In some embodiments, precipitation in the precipitation zone of the extruder 112 can be achieved by injecting a solvent that is not a good solvent for rubber 150, but is a solvent for residual resin 90 components (e.g., acetone or other ketones). In some embodiments, the precipitation process can be enhanced, and the viscosity of the solution and the nature and form of the precipitate can be controlled by control of temperature. In some embodiments, optionally steam can be injected to selected process zones to enhance precipitation, solvent removal or both. In some other embodiments, optionally, the rubber 150 can be precipitated in a separate process step that is outside of the extruder 112. For example, in some embodiments, the rubber 150 can be precipitated in a reactor and the solids separated and fed into the twin screw devolatilizing extruder 112 as above to produce substantially resin 90 free guayule crumb or solid block rubber 150. In this instance, the extruder 112 is used for the removal of trace resin 90 contaminants in the washing zones, and de-volatilization of the rubber 150, and mixing of stabilizers (such as antioxidants 120).

In some further embodiments, stabilizers (such as antioxidants 120) can be added to at least some portion of the guayule shrub 60 just prior to or during plant size reduction. For example, in some embodiments, one or more stabilizers 120 can be added to harvested guayule whole shrub 60a, guayule bark 60b, or guayule shrub 60c that is at least partially defoliated. In some alternative embodiments, one or more stabilizers 120 can be added to the guayule whole shrub 60a in the field. For example, in some embodiments, one or more stabilizers 120 can be added to guayule whole shrub 60a in the field by spraying the crop in the field just prior to harvesting, or alternatively at some stage in the growing season. In some embodiments, the stabilizers (such as antioxidants 120) can include at least one bioavailable stabilizer 120. In some embodiments, at least one stabilizer 120 can be systemically, or at least partially absorbed by the guayule whole shrub 60a.

In some embodiments, the antioxidant 120 can be a sterically hindered phenol, and in other embodiments, the antioxidant 120 can be a hydroquinone derivative. In some embodiments, the antioxidant 120 can be a paraphenylene diamine derivative. In some embodiments of the invention, the stabilizer can include more than one antioxidant 120. For example, in some embodiments, the antioxidant 120 can include a mixture of a sterically hindered phenol and a hydroquinone derivative. In some other embodiments, the antioxidant 120 can comprise a mixture of a butylated reaction product of p-cresol and dicyclopentadiene (CAS. Reg. No. 68610-51-5) and an aqueous mixture of 2,5-Di(Tert-Amyl) Hydroquinone (CAS. Reg. No. 79-74-3) and Sodium Salts of Polymerized Alkylnaphthalenesulfonic Acid (CAS. Reg. No. 9084-06-4/36290-04-7). In some other embodiments, the antioxidant 120 can include Octadecyl 3,5-Di(tert)-butyl-4-hydroxyhydrocinnamate) (CAS. Reg. No. 2082-79-3), and in some other embodiments, the antioxidant can be a synergistic blend of polymeric hindered phenol and thioester (dilaurylthiodipropionate) (CAS. Reg. No. 68610-51-5 and CAS. No. 123-28-4. In some further embodiments, the antioxidant can comprise N,N′-di-beta-naphthyl-p-phenylenediamine, 55% casein free dispersion (CAS. Reg. No. 93-46-9). In some further embodiments, the stabilizer can include at least some proportion of an antioxidant 120 comprising a 50% active aqueous dispersion of polymerized 1,2 Dihydro-2,2,4-Trimethylquinoline (CAS. Reg. No. 26780-96-1).

In some embodiments, the antioxidant 120 can be a solid or a semi-solid material, and can comprise a crystalline, partially crystalline, or amorphous powder. In some other embodiments, the antioxidant 120 can be a liquid, an emulsion, or dispersion.

In some alternative embodiments, optionally, the solution 106 can be directly fed into the devolatilizing extruder 112 if the viscosities are sufficiently high (i.e., without passing through a wiped-film evaporator in step 108). In this instance, the devolatilized solvent vapors from the extruder 112 (i.e. solubilizing medium 101) can be condensed in the solvent recovery unit 115, purified and delivered to solvent storage tanks. In some embodiments, the solubilizing medium 101 (such as hexane) can then be fed back into the dissolution homogenizers as required (in steps 94, 98) to complete the continuous process loop. In other embodiments, optionally, other processes such as precipitation using a non-solvent can also be used to separate the rubber 150. In other embodiments, steam stripping or down-stream processing steps currently used to make dry solid rubber 150 from solution polymerized synthetic rubber 150 production processes can be used. In some embodiments, the bagasse 75b separated in the second separation process 102 is continuously dried in step 104, and the hexane solvent from the drier is recovered in the hexane solvent recovery unit 115. In some embodiments of the invention, the above process can produce purified resin 90 and dry bagasse 75c.

In some embodiments, at least one by-product of processing guayule shrub 60 (e.g., bagasse 75c) can be converted into at least other product. For example, in some embodiments, guayule fiber biomass can be converted into an animal feed material suitable for animal consumption. In some embodiments, guayule fiber can be converted into an animal feed material with a conversion process that can include at least partially include hydrolyzing guayule fiber. In some embodiments, the conversion process can include at least partially include hydrolyzing guayule fiber using a strong base. The strong base can be any base known in the art to be suitable for hydrolysis of cellulosic plant material. For example, in some embodiments, the strong base can include at least one hydroxide of alkali metals and alkaline earth metals. In some embodiments, the strong base can include at least one alkali metal hydroxide, or a mixture of alkaline earth metal hydroxides. In some other embodiments, the strong base can include a mixture of hydroxides of alkali metals, and a mixture of alkaline earth metals. For example, some embodiments include a process 200 for converting guayule fiber into animal feed. For example, FIG. 2 provides a flowchart illustrating an example of a process 200 for converting guayule fiber into animal feed according to one embodiment of the invention. As shown, in some embodiments, guayule fiber 210 (e.g., such as bagasse 75b, 75c) is introduced into the process 200, and residual solvent is removed in the process step 220. In some embodiments, a subsequent process step 230 can include processing within an agitation tank. Further, some embodiments include a process step 235 for addition of soft water and a strong base (such as an alkali metal hydroxide, or a mixture of alkaline earth metal hydroxides). In some embodiments, the process step 235 can proceed as part of the process step 230, and can be included during the agitation process. In this instance, fiber agitation 240 can proceed as the fiber is agitated within the agitation tank in the process step 230. In some embodiments, a process step 245 can be maintained at a temperature between 0° C. and 250° C. In some embodiments, the process step 245 includes heating the contents of the agitation tank within the process step 230 up to about 250° C. In some embodiments of the invention, following the process step 230 including fiber agitation 240, the process 200 can include proceeding to a process step 250 comprising the passing fiber slurry to a dewatering press or a decanter. In some embodiments, upon conversion to fiber slurry, the fiber slurry can enter a de-watering press or decanter from the agitation tank, and liquid can be discarded from this step, or filtered and reused in process step 260 including a reuse option step 265. In a further embodiment, fiber 210 can be sent to dryer in step 270. In some embodiments, following a least partial removal of water from the fiber 210, fiber 210 with reduced moisture can be transported for packaging and sent to a user in step 280.

In some embodiments, the acetone extraction process step can be replaced by ‘supercritical’ or ‘subcritical’ carbon dioxide as detailed in U.S. Pat. No. 7,259,231, the entire contents of which is incorporated by reference. In some embodiments, supercritical’ or ‘subcritical’ carbon dioxide as detailed in U.S. Pat. No. 7,259,231 is used to remove substantial portion of resin 90, non-rubber constituents, and other undesirable components, followed by hydrocarbon (for example liquid hexane) as detailed in the second step. In another embodiment, the hydrocarbon extraction can be replaced by ‘supercritical’ hydrocarbon extraction using hydrocarbons such as natural gas, methane, ethane, propane, butane and the like, alone or as blends. In some other embodiments, optionally, additional co-solvents up to about 5 weight percent can be added to match the solubility parameter of the rubber 150. In another embodiment, the hydrocarbon extraction in step two can be replaced by ‘supercritical’ hydrocarbon extraction using hydrocarbons such as natural gas, methane, ethane, propane, butane and the like with ‘supercritical’ carbon dioxide. In other embodiments, optionally, additional co-solvents can be added to match the solubility parameter of the rubber 150.

In another embodiment of the invention, the guayule shrub 60 can be milled, using milling equipment used by the paper pulping industry, to produce guayule rubber 150 “worms” comprised of a porous mixture of rubber 150 and resin 90. In this process, the guayule shrub 60 is coarsely ground in presence of water and potassium hydroxide (added to break open the plant cells). In some embodiments, a pulp of bagasse and rubber “worms” (comprising rubber 150) can be fed into a tank to remove the “worms” by floatation. In some embodiments, the separated “worms” can be purified and fed into a twin screw de-volatizing extruder 112 with different multiple process zones as in the process as described earlier. In some embodiments, the twin screw extruder 112 can remove the resin 90, strip the solvents, and can add and mix the stabilizers 120 in a continuous operation. In some embodiments, optionally, the rubber “worms” can be dissolved in a solvent, and subsequently filtered and purified, and then fed into the twin screw extruder 112 process to encourage removal of resin 90, and drive precipitation and devolatization of rubber 150.

In some further embodiments, a rubber 150 solution produced by the methods and process described can be converted to artificial latex. For example, in some embodiments, the rubber 150 solution can be converted to artificial latex by emulsifying the solution in water using emulsifying agents, and then removing the solvent. In some embodiments, the emulsification process can be carried out using commercial rotor-stator assemblies or similar equipment in a batch or continuous mode under high speed agitation (tip-speed). In some embodiments, the solvents can be removed by steam distillation, distillation under reduced pressure, or heat or combinations of steam, vacuum and heat. In some embodiments, the latex can be concentrated to a solid by creaming, centrifugation, or evaporation, or any combinations of these processes. In some other embodiments, emulsifiers can be anionic, non-ionic, or cationic emulsifiers. In some embodiments, it is preferred that the emulsifiers be anionic, or a combination of anionic and non-ionic for coagulant dipping applications. One example of an emulsifier that can be used with the methods as described includes rosin acid soaps, such as potassium salt of rosin acid. This emulsifier typically produces very low foam during the solvent stripping processes, and can also be used under coagulant dipping in making dipped goods. In general, useful anionic emulsifiers can include rosin acid soaps, potassium oleate, sodium salt of alkyl benzene sulfonic acid and the like. In some embodiments, the rubber 150 can also be modified with functional groups such as carboxylic acid groups to facilitate emulsification, if desired by known processes.

In some embodiments, the emulsifier or soap can be prepared from guayule extracts. For example, the acetone or alcohol extract residues (guayule resin 90) from guayule shrub 60 can be saponified using a strong base such as sodium hydroxide and converted into an emulsifier. In some embodiments, the process can be carried out in a reactor, in a batch mode, or a continuous mode (for example using jet saponification). In some embodiments, optionally, a phase transfer catalyst can be used in the process. In some embodiments, the process can also be carried out by steam. In some embodiments, the emulsifiers can modify the properties of the rubber 150 (for example, it can produce a material with a lower modulus). In some embodiments, any known saponification chemistry can be used to convert the extract residues to an emulsifier or soap.

The antioxidant 120 can be applied by any conventional application method including spraying the antioxidant 120 as a liquid, solid or semi-solid directly onto at least some portion of the harvested guayule shrub 60. In some other embodiments, the antioxidant 120 (either in the form of a liquid, solid or semi-solid) can be physically mixed with the harvested guayule shrub 60. As described earlier, in some embodiments, one or more stabilizers 120 can be added to guayule whole shrub 60a in the field by spraying the crop in the field just prior to harvesting, or alternatively at some stage in the growing season.

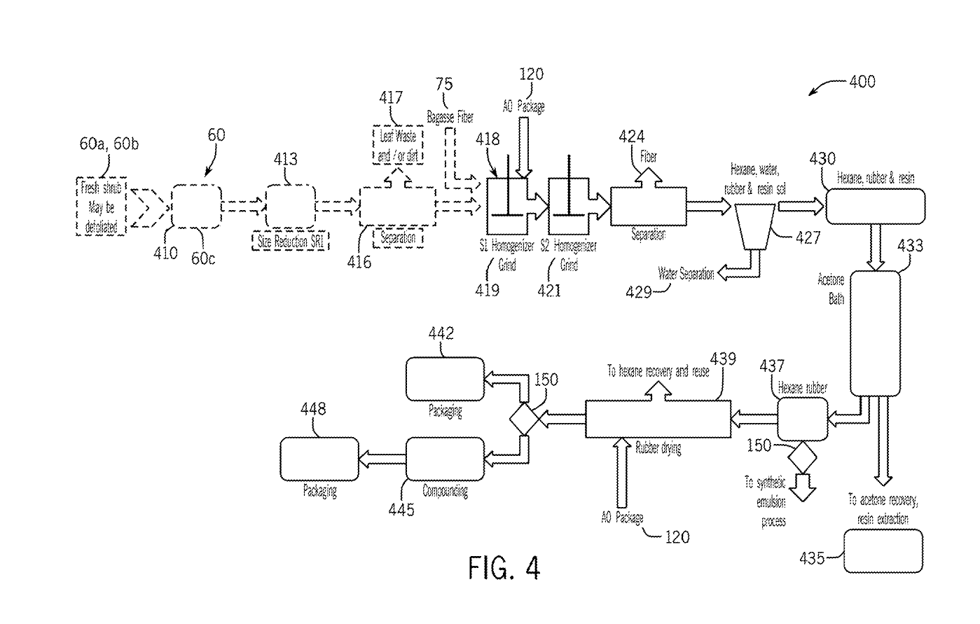

FIG. 4 provides one illustration of a production process 400 for producing non-hevea natural rubber according to one embodiment of the invention. In some embodiments, harvested guayule shrub 60, optionally including at least some portion comprising an antioxidant 120, can be transported to a primary separation in step 416. In some embodiments, the guayule shrub 60, and/or optionally the guayule bark 60b alone, and/or defoliated shrub 60c can proceed to a size reduction step 413, followed by a separation step 416 which can include a step 417 for removal of leaf and/or dirt. In some embodiments, material emerging from the separation step 416 and including bagasse fiber 75, can proceed to a plurality of grinding and homogenization steps including a first homogenization grind 419 and a second homogenization grind 421. In some embodiments, a milling solvent 418 can be added to the first homogenization grind 419 step, and in some embodiments, antioxidant 120 can be included (e.g., the antioxidant 120 can be added directly to the first homogenization grind 419 in some embodiments, and can be added mixed or dissolved with the milling solvent 418 in some other embodiments). During at least the first homogenization grind 419 and/or the second homogenization grind 421, rubber 150 contained within the cellular structure of the guayule shrub 60 can be liberated and solubilized by the milling solvent 418. In some other embodiments, the solvent can be hexane, pentane, or other similar linear or cyclic hydrocarbon.

In some embodiments, a water separation step 429 can proceed the first homogenization grind 419 and the second homogenization grind 421, and a solution 427 comprising substantially of milling solvent 418 (e.g., hexane), rubber 150 and resin 90 can proceed to an acetone bath step 433. In some embodiments, the temperature can be controlled from ambient to sub-zero temperatures, above the freezing point of the solvent to above ambient temperatures below the vapor point of the solvent. Further, in some embodiments, the step 433 can comprise an acetone and resin recovery step 435. In this instance, solvent can be extracted and optionally reused. In some embodiments, a milling solvent 418 and rubber 150 solution (e.g., rubber 150 in a solution of hexane) can be converted to a synthetic emulsion. In some further embodiments, the milling solvent 418 (e.g., hexane) can be recovered and reused in a step 439. Rubber 150 can then emerge from step 439 and proceed to a packaging step 442, or alternatively to a compounding step 445, followed by a packaging step 448.

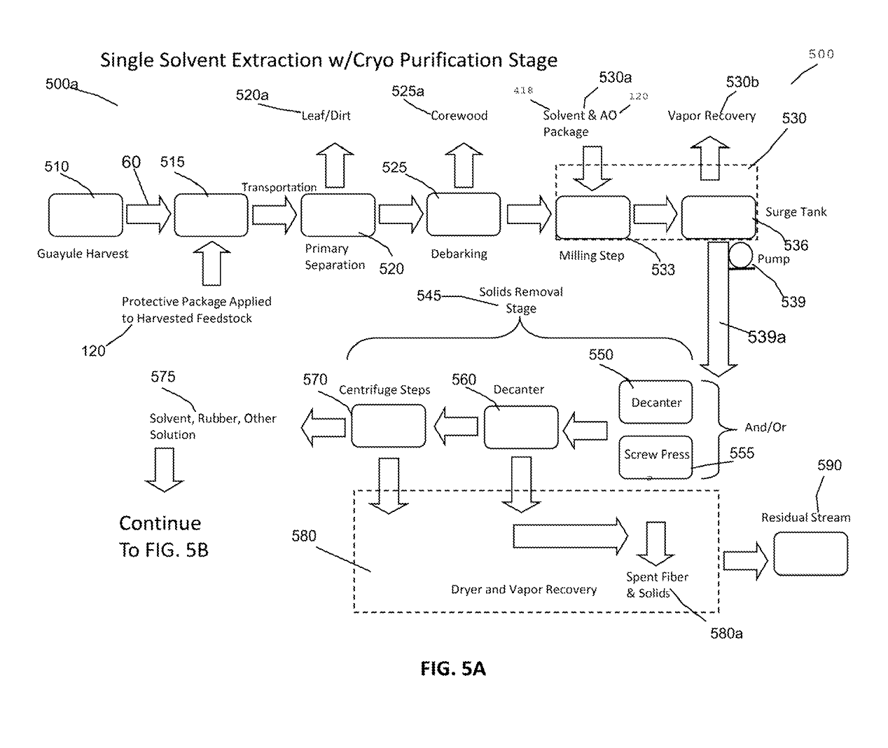

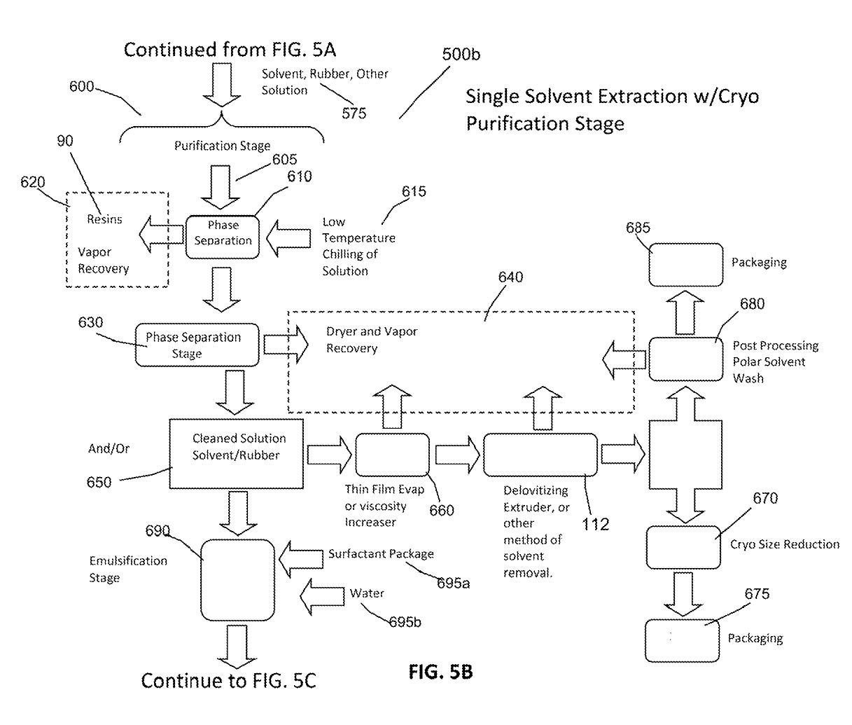

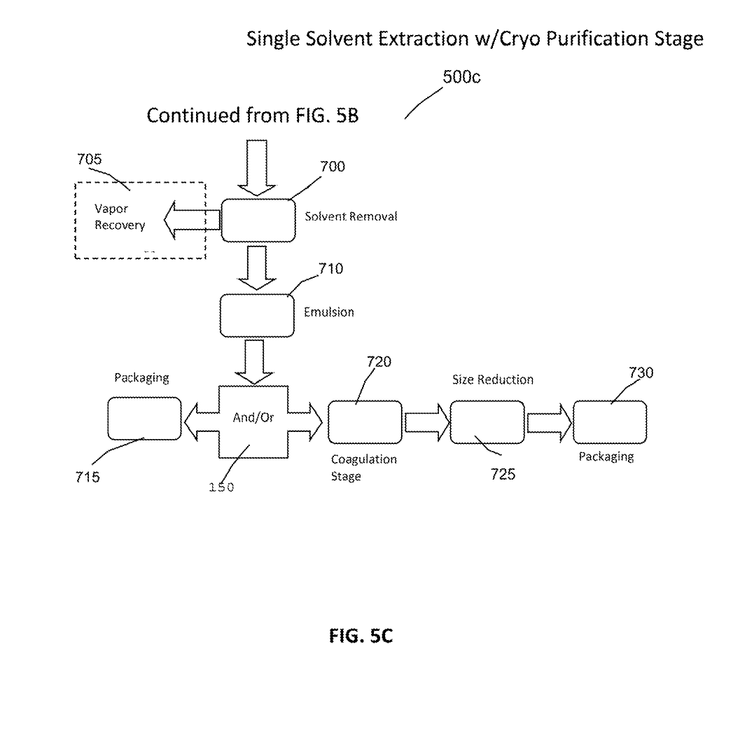

In some embodiments, a solvent extraction using a single solvent with a cryogenic purification stage can be used to process guayule shrub 60 that optionally can included an antioxidant 120. For example, embodiments of the above-mentioned processes can be shown by way of example in FIGS. 5A-5C collectively illustrating (in combination) a process flowchart 500 comprised of process flowchart portions 500a, 500b, 500c illustrating a process for single solvent extraction with a cryogenic extraction. For instance, FIG. 5A shows a first portion 500a of a process flowchart 500 illustrating a process for single solvent extraction with a cryogenic extraction stage. In some embodiments, following a guayule shrub 60 harvest step 510, a protective package material (e.g. an antioxidant 120) can be applied to the harvested feedstock (guayule shrub 60) in step 515.

In some embodiments, harvested guayule shrub 60 including at least some portion comprising an antioxidant 120 can be transported to a primary separation in step 520. In some embodiments, the guayule shrub 60, or optionally the guayule bark 60b alone (from a debarking step 525), can be extracted with a single solvent within an extraction stage 530. For example, in some embodiments, following removal of leaf and/or dirt 520a and/or corewood 525a in the primary separation 520 and debarking steps 525, a solvent (milling solvent 418) can be added to the guayule shrub 60 materials emerging from these steps and extraction can proceed by milling in step 533 and immersion in a bath of the solvent in step 536. In this instance, rubber 150 contained within the bark cellular structure can be liberated and solubilized by the milling solvent 418. In some embodiments, the milling step 533 can utilize a conventional high speed homogenizer. In some embodiments, the milling solvent 418 can comprise cyclopentane as the only solvent. In some other embodiments, the solvent can be pentane, or other similar linear or cyclic hydrocarbon. In some embodiments, the temperature of the milling solvent 418 and/or vessel temperatures in step 536 can be controlled from ambient to sub-zero temperatures, above the freezing point of the solvent to above ambient temperatures below the vapor point of the solvent. Further, in some embodiments, one or more steps of the extraction stage 530 can be performed at pressures from atmospheric to higher pressures if desired. For example, in some embodiments, the milling step 533 can be performed at atmospheric or higher pressures and/or the bath or vessel used in step 536 can be pressurized to atmospheric or higher pressures. In some further embodiments, the extraction stage 530 can comprise a vapor recovery step 530b. In this instance, solvent can be extracted and optionally reused. In some further embodiments of the process, the extraction stage 530 can comprise addition of antioxidant 120. For example, in some embodiments, antioxidant 120 can be added to the milling solvent 418 during the milling step 533 (in step 530a).

In some embodiments of the process methods as described herein, at least some fraction of the antioxidant 120 can be at least partially dispersed within the rubber 150 to form a sub-nanometer-sized phases. In other embodiments, at least some fraction of the antioxidant 120 can be at least partially dispersed within the rubber 150 to form at least nano-sized phases within the rubber 150. In other embodiments, at least some fraction of the antioxidant 120 can be at least partially dispersed within the rubber 150 to form a sub-micron-sized phases within the rubber 150. In other embodiments, at least some fraction of the antioxidant 120 can be at least partially dispersed within the rubber 150 to form substantially micron-sized phases within the rubber 150. In some other embodiments, at least some fraction of the antioxidant 120 can be at least partially dispersed within the rubber 150 to form phases that are larger than 1 micron.

In some embodiments, the rubber 150 processed by the methods as described can include at least some fraction of an antioxidant 120 that is mixed at the molecular level with to form a single phase natural rubber and antioxidant 120, and at least some fraction that comprises a second phase comprising substantially antioxidant 120. In some embodiments, the rubber 150 can comprise a homopolymer or a substantially miscible polymer blend. In some embodiments, one or more components of a stabilizer (such as the aforementioned antioxidant 120) can form one or more molecular bonds with one or more molecular bonds of at least one component of the rubber 150. In some other embodiments, one or more components of the antioxidant 120 can form one or more covalent bonds with one or more molecular bonds of at least one component of the rubber 150. In other embodiments, one or more components of the antioxidant 120 can form one or more ionic bonds with one or more molecular bonds of at least one component of the rubber 150. In some other embodiments, one or more components of the antioxidant 120 can form one or more hydrogen bonds with one or more molecular bonds of at least one component of the rubber 150. Some embodiments can include one or more components of the antioxidant 120 at least partially bonded to at least one component of the rubber 150 by Van der Waals forces.

In general, antioxidants that are used in rubber are classified as staining if the antioxidant darkens the color of the vulcanizate (cured rubber), and are classified as non-staining if there no substantial darkening. Staining is not generally of a concern for black colored products that can contain a darkening additive, such as carbon-black, but it can be of significance in lighter colored products. Some embodiments include a staining antioxidant 120, but other embodiments can include a substantially non-staining antioxidant 120.

In some embodiments, the milled guayule rubber 150, fiber and solvent mixture that can emerge from the extraction stage 530 can be cleaned and separated by methods comprising a solids removal stage 545. In some embodiments, the solids removal stage 545 can comprise using combinations of gravity, decanters, screw presses, centrifuges and the like. For example, as depicted in FIG. 5A, the fiber and residual solvent stream 539a can be passed to a solids removal stage 545 (e.g., using a pump 539) which is then presented to a solvent vapor recovery system 580 for reuse in step 590. In some embodiments, decanters 550, 560 and/or a screw press 555 can be used as well as one or more centrifuge steps 570 to produce a clean extracted solution 650 (i.e. a solution of rubber 150) and separated components comprising spent fiber and solids 580a.

In some embodiments, a solution 575 comprising rubber 150 can emerge from the solids removal stage 545 and can be converted into solid rubber 150 using known processes used in conventional synthetic rubber processing. In some embodiments, a devolatilizing extruder 112, steam, air dry coagulation, vacuum drying and other similar conventional methods can be used to convert the solution of rubber 150 emerging from the process depicted in the flowchart portion 500a in FIG. 5A to a solid rubber 150.

In some embodiments, the solution 575 obtained by the processes described above and depicted in the flowchart portion 500a in FIG. 5A can be further purified by one or more additional separation processes within a process 600. For example, FIG. 5B shows a second portion 500b of a process flowchart 500 illustrating a process 600 for single solvent extraction with a cryogenic extraction stage according to another embodiment of the invention. In some embodiments, the process 600 can be used to produce purified high molecular weight solid rubber 150. For example, in some embodiments, the solution 575 can be cleansed of resin 90 elements by one or more phase separation steps (610, 630). For example, in some embodiments, the solution 575 can then be conveyed 605 to a column of chilled acetone or other polar solvent 615, and can be further fractionated to remove unwanted resin 90 and low molecular weight components by lowering the temperature of the solution to substantially near the freezing point of the solvent. In the case of chilled acetone, the acetone can be chilled to a temperature as low as −78° C. using dry-ice. In some embodiments, the column 615 comprises an acetone and dry-ice mixture. In some embodiments, the column 615 can be cooled to a temperature between 32° C. and −78° C. In this instance, the step 610 can include separation due to mass differential, phase partitioning, and similar processes. In some embodiments, as the polar solvent moves downward, it can extract resin 90, and further precipitate the rubber 150 to form a clean rubber gel containing rubber 150 and an amount of process solvent (generally non-polar). In some embodiments, at least some fraction of the polar solvent is recirculated and distilled (shown as step 620). In some embodiments, the gel phase rubber 150 is removed from the bottom of the column using a suction pump, and discharged to a holding vessel for the next stage of the process. Some embodiments can also include a further phase separation step 630 followed by a dryer and vapor recovery step 640.

In some further embodiments, clean extracted solution 650 emerging from the phase separation step 630 can proceed to one or more steps for drying the fractionated high molecular weight rubber 150. For example, in some embodiments, this can be accomplished using processes used in synthetic rubber production (e.g., such as using a devolatilizing extruder 112, steam or other similar methods). In some embodiments, thin film evaporators or other conventional viscosity increasers 660 can be used to reduce the solvent residue levels. Further, in some embodiments, other processing steps can include a post-processing polar solvent wash 680 followed by drying and vapor recovery 640, along with subsequent packaging steps 685. In some further embodiments, other processing steps can include cryo-size reduction 670, followed by packaging 675.

In some embodiments, synthetic latex can be prepared from rubber 150 containing solutions using one or more known processes shown in the flowchart portions 500a, 500b, 500c. In some embodiments, the emulsification process can be carried out using commercial rotor-stator assemblies or similar equipment in a batch or continuous mode under high speed agitation (tip-speed). For example, in some other embodiments, the clean extracted solution 650 can be emulsified to obtain synthetic latex rubber 710. In some embodiments, the clean extracted solution 650 can be converted to artificial latex using a process step 690 by emulsifying the solution in water 695b using emulsifying agents 695a, and followed by solvent removal (steps 700, 705). In some embodiments, the emulsifiers 695a can be anionic, non-ionic, or even cationic surfactants. In some embodiments, it is preferred that the emulsifiers 695a be anionic or a combination of anionic and non-ionic for coagulant dipping applications. Many anionic emulsifiers can be used, and typical anionic emulsifiers can include, but are not limited, to rosin acid soaps, potassium oleate, sodium salt of alkyl benzene sulfonic acid and the like. In some embodiments, rosin acid soaps, such as potassium salt of rosin acid are preferred. This material normally gives very low foam during solvent stripping processes, and also performs well under coagulant dipping in making dipped goods. In one embodiment, the emulsifier or soap can be prepared in-situ by saponification of the extract using a strong base. Optionally, a phase transfer catalyst can be used in the process.

FIG. 5C shows a third portion 500c of a process flowchart 500 illustrating a process for single solvent extraction with a cryogenic extraction stage according to another embodiment of the invention. In some embodiments, step 700 can include removal of solvents by one or more processes including steam distillation, by distillation under reduced pressure or heat, or by combinations of steam, vacuum and heat to synthetic latex rubber 710. Further, in some embodiments, the synthetic latex rubber 710 can be concentrated to desired solids (to rubber 150) by creaming, centrifugation, or evaporation, or a combination of these processes (steps 720, 725) and/or packaged for delivery to customer (steps 715, 730).

In some embodiments, the synthetic latex rubber 710 can be converted into solid rubber 150 by coagulation processes, and used in making crumb rubber 150, or using processes as detailed in U.S. Provisional Patent Application Ser. No. 61/758,684. In some embodiments, the non-rubber contaminants in the synthetic latex rubber 710 can be removed in the coagulation process using a polar solvent. In some embodiments, the “fractionated purified rubber solution” can be converted into synthetic latex rubber 710 by using processes detailed earlier. In some embodiments, purified synthetic latex rubber 710 can be prepared from fractionated purified extract can be converted into solid rubber 150 by coagulation processes (e.g., such as those for making crumb rubber) or by using processes as detailed in U.S. Provisional Patent Application Ser. No. 61/758,684. These are preferred for tire applications and for pure rubber 150 meeting medical grade requirements.

Using the methods as described throughout and in FIGS. 1, 2, 4, and 5A-5C, the rubber 150 can meet or exceed the various physical parameters measured according to various ASTM standards. For example, in some embodiments, the Mooney Retention Index can be measured according to ASTM D1646-07. In some embodiments, the Mooney Retention Index can be measured on rubber 150 produced by the methods described and disclosed soon after the material exits one or more of the processes as described herein. In some other embodiments, the aging characteristics of the rubber 150 can be measured after the rubber 150 has undergone accelerated aging. In general, an accelerated aging process can expose the rubber 150 to an elevated temperature for periods of time, in specific atmospheric or light conditions, to simulate the effects of a generally longer period of time and general lower temperature (usually ambient and/or expected service-life temperature).

In some embodiments of the invention, rubber 150 produced by the methods described and disclosed were prepared and aged according to a modified version of the ASTM D3194-04. In some embodiments, the aging temperature used was 143° C. This aging temperature was used in place of the 140° C. aging temperature as taught in ASTM D3194-04. In some embodiments, rubber 150 produced by the methods described and disclosed was prepared and aged according to a modified version of the ASTM D3194-04 using the aging temperature of 143° C. As used within the specification, the term heat aged or heat aging refers to performing an accelerated aging at a temperature of 143° C.

Using the methods as described throughout and in FIGS. 1-2, 4, and 5A-5C, a rubber 150 can be produced that provides a Mooney Retention Index of at least 85% after it has undergone thermal aging at 143° C. for 30 minutes as described above. In some further embodiments of the invention, a rubber 150 can be extracted from the methods as described to produce a natural rubber with a Mooney retention index of at least 70% after it has undergone thermal aging at 143° C. for 30 minutes measured as described above. In some further embodiments of the invention, a rubber 150 can be extracted from the methods as described to produce a natural rubber with a Mooney retention index of at least 60% after it has undergone thermal aging at 143° C. for 30 minutes measured as described above.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

What is claimed is:

1. A process for separating rubber, resin and bagasse from a rubber producing plant comprising the steps of:
providing a plant portion;
at least partially homogenizing the plant portion in the presence of a resin-solubilizing medium;
solvating at least some portion of a resin from the plant portion to form a resin solution and bagasse;
performing a first separation process comprising separating at least a portion of the resin solution from the bagasse;
recovering resin by removing the resin-solubilizing medium and optionally capturing and reusing the resin-solubilizing medium;
at least partially homogenizing the bagasse in a rubber solubilizing solvent to at least partially de-resinate the bagasse and form a rubber solution;
performing a second separation process comprising at least partially separating and isolating the rubber solution and the bagasse;
processing the rubber solution to produce rubber by at least partially removing the rubber solubilizing solvent and processing the bagasse by at least partially removing the rubber solubilizing solvent,
optionally recovering the rubber solubilizing solvent for reuse; and
drying the rubber and the bagasse.

2. The process of claim 1, wherein the plant portion comprises a whole guayule shrub.

3. The process of claim 1, where the plant portion comprises at least partially defoliated guayule shrub.

4. The process of claim 1, where the plant portion comprises guayule bark.

5. The process of claim 1, wherein the resin solubilizing medium comprises a ketone.

6. The process of claim 5, wherein the ketone comprises 3 to 8 carbon atoms.

7. The process of claim 1, wherein the resin solubilizing medium comprises at least one of acetone, esters, alcohols, ethoxylated alcohols, ethoxylated alcohol and water mixtures, and combinations thereof.

8. The process of claim 1, wherein the first separation process is performed using at least one of a decanter centrifuge and a screw press.

9. The process of claim 1, wherein the second separation process is performed using at least one of a decanter centrifuge and a screw press.

10. The process of claim 1, wherein the rubber solubilizing medium is at least one of a linear hydrocarbon comprising 1 to 12 carbon atoms, a cyclic hydrocarbon, and aromatic hydrocarbon, and mixtures thereof.

11. The process of claim 10, wherein the rubber solubilizing medium comprises hexane or hexane isomers.

12. The process of claim 1, wherein the resin-solubilizing medium is removed from the resin using at least one wiped film evaporator.

13. The process of claim 1, wherein the rubber solubilizing solvent is removed from the rubber solution using at least one wiped film evaporator.

14. The process of claim 1, wherein the rubber solubilizing solvent is removed from the rubber solution using a twin screw extruder.

15. The process of claim 3, where the at least partially defoliated guayule shrub is produced using a defoliation assembly, the defoliation assembly comprising two sub-assemblies including at least one cutting head and at least one carrier belt, and at least one defoliating roller head.

16. The process of claim 1, wherein the bagasse is at least partially converted to an animal feed material using a process comprising the steps of:
at least partially removing any residual resin-solubilizing medium and rubber solubilizing solvent from the bagasse;
agitating the bagasse with at least one alkali metal hydroxide while maintaining a temperature substantially between about 0° C. and about 250° C. to at least partially convert the bagasse to the animal feed material;
at least partially removing water from the animal feed material using at least one of a dewatering press and a decanter;
optionally filtering and recovering the water for reuse; and
drying the animal feed material.

17. A guayule solid rubber made according to the process of claim 1, wherein the guayule solid rubber meets or exceeds a technical grade 10 in accordance with the standard specification for natural Rubber (NR) Technical Grades of ASTM D2227-96 (Reapproved 2007).

18. The process of claim 1, wherein the rubber produced by the process shows a Mooney retention index of at least about 85% after heat aging at 143° C. for 30 minutes in a forced air circulating oven.

19. The process of claim 1, wherein the rubber produced by the process shows a Mooney retention index of at least about 70% after heat aging at 143° C. for 30 minutes in a forced air circulating oven.

20. The process of claim 1, wherein the rubber produced by the process shows a Mooney retention index of at least about 60% after heat aging at 143° C. for 30 minutes in a forced air circulating oven.

21. A guayule solid rubber made according to the process of claim 1, wherein the guayule solid rubber comprises at least one antioxidant with a concentration from about 0.25 phr to about 3 phr, that meets or exceeds a technical grade 10 in accordance with the standard specification for natural Rubber (NR) Technical Grades of ASTM D2227-96 (Reapproved 2007).

22. The process of claim 1, wherein the plant portion includes at least one added antioxidant.

23. The process of claim 21, wherein the at least one added antioxidant comprises a substantially non-staining antioxidant.

24. The process of claim 22, wherein the at least one added antioxidant is at least one of a sterically hindered phenol, a hydroquinone derivative, a paraphenylene diamine derivative, a mixture of a sterically hindered phenol and a hydroquinone derivative.

25. The process of claim 22, wherein the antioxidant comprises at least one antioxidant selected from a group consisting of a mixture of butylated reaction product of p-cresol and dicyclopentadience (CAS. Reg. No. 68610-51-5) and an aqueous mixture of 2,5-Di(Tert-Amyl)Hydroquinone (CAS. Reg. No. 79-74-3) and Sodium Salts of Polymerized Alkylnaphthalenesulfonic Acid (CAS. Reg. No. 9084-06-4/36290-04-7), Octadecyl 3,5-Di(tert)-butyl-4-hydroxyhydrocinnamate) (CAS. Reg. No. 2082-79-3). a synergistic blend of polymeric hindered phenol and thioester (dilaurylthiodipropionate) (CAS. Reg. No. 68610-51-5 and CAS. No. 123-28-4, N,N′-di-beta-naphthyl-p-phenylenediamine, 55% casein free dispersion (CAS. No. 93-46-9), and a 50% active aqueous dispersion of polymerized 1,2 Dihydro-2,2,4-Trimethylquinoline (CAS. No. 26780-96-1).

26. A process for separating rubber, resin and bagasse from a rubber producing plant comprising the steps of:
providing a plant portion and applying at least one antioxidant to at least a fraction of the plant portion;
optionally performing a primary separation step to remove at least a portion of leaves and optionally at least a portion of dirt;
optionally performing a defoliating step and removing corewood;
performing an extraction step comprising milling the plant portion with a milling solvent, the milling solvent solvating at least some fraction of rubber from the plant portion to form a rubber solution;
performing a solids removal stage to at least partially separate fiber and solids from the rubber solution;
performing a purification step by inducing phase separation of the rubber solution at least once by mixing the rubber solution with a fractionation solvent, the fractionation solvent solvating at least some fraction of resin from the rubber solution to enable separation of resin from the rubber solution.

27. The process of claim 26, wherein the milling solvent can include at least one antioxidant.

28. The process of claim 26, wherein the fractionation solvent comprises a polar solvent.

29. The process of claim 26, wherein the fractionation solvent comprises acetone.

30. The process of claim 28, wherein the phase separation of the rubber solution and fractionation solvent is induced by mixing the rubber solution with acetone at a temperature between about 32° C. and about −78° C.

31. The process of claim 26, wherein the purification step comprises two sequential phase separation steps.

32. The process of claim 26, and further comprising:
at least partially removing milling solvent and increasing the viscosity of the rubber solution;
processing the rubber solution using a devolatilizing extruder;
extruding rubber; and
optionally capturing the milling solvent for reuse.

33. The process of claim 26, and further comprising:
at least partially removing milling solvent and increasing the viscosity of the rubber solution;
optionally capturing the milling solvent for reuse; and
at least partially converting the rubber solution into a rubber latex solution through the addition of at least one emulsifier.

34. The process of claim 33, wherein the at least one emulsifier comprises at least one of an anionic, non-ionic, and cationic surfactant.

35. The process of claim 33, where the at least one emulsifier includes an anionic emulsifier comprising rosin acid soaps, potassium salt of rosin acid, potassium oleate, and sodium salt of alkyl benzene sulfonic acid.

36. The process of claim 33, wherein the fiber is at least partially converted to an animal feed material using a process comprising the steps of:
at least partially removing any residual milling solvent from the fiber;
agitating the fiber with at least one alkali metal hydroxide while maintaining a temperature substantially between about 0° C. and about 250° C. to at least partially convert the bagasse to the animal feed material;
at least partially removing water from the animal feed material using at least one of a dewatering press and a decanter;
optionally filtering and recovering the water for reuse; and
drying the animal feed material.
